(19) United States
(12) Patent Application Publication
(10) Pub. No.: US 2009/0071877 A1
(43) Pub. Date: Mar. 19, 2009

(54) Apparatus and Method for Transporting Lunar Soil

(76) Inventors: Lawrence August Taylor, Lenoir City, TN (US); Michael A. DiGiuseppe, Milford, NJ (US)

Correspondence Address: PIETRAGALLO GORDON ALFANO BOSICK & RASPANTI LLP, ONE OXFORD CENTRE, 38TH FLOOR, 301 GRANT STREET, PITTSBURGH, PA, 15219-6404, US

(21) Appl. No.: 12/180,319

(22) Filed: Jul. 25, 2008

Related U.S. Application Data
(60) Provisional application No. 60/951,760, filed on Jul. 25, 2007.

(51) Int. Cl. B03C 1/30

(52) U.S. Cl. 209/214; 209/215

(57) ABSTRACT

An apparatus and method for transporting lunar soil is disclosed. A magnetic field is generated in a transport tube which attracts and moves the lunar soil through the tube. The magnetic field may be generated by multiple electrically conductive coils that are positioned coaxially and along the length of the transport tube.

### CROSS-REFERENCE TO RELATED APPLICATION

This application claims the benefit of U.S. Provisional Application No. 60/951,760 filed Jul. 25, 2007, which is incorporated herein by reference.

### FIELD OF THE INVENTION

The present invention relates to transport of lunar soil, and more particularly relates to an apparatus and method for transporting lunar soil containing nano-sized metallic iron particles.

### BACKGROUND INFORMATION

NASA and the Apollo astronauts who walked on the Moon have stated that one of the foremost problems to be solved before we return to the Moon concerns lunar dust. This fine (e.g., less than 20 microns) portion of the lunar soil makes up about 20 wt % of the total soil and is extremely clinging, abrasive, toxic and omnipresent. Many activities on the Moon are negatively affected by this dust. During the Apollo missions, it caused reduced movement in the joints of the astronauts' space suits and wore through layers of the Kevlar cloth of the suits. Its clinging nature caused the initially white suits to become dirty, thereby absorbing more black-body heat with each Moon walk. In the lunar module when the astronauts removed their helmets, they experienced distressing sensations from the dust in their eyes, noses, and throats. Equipment having moving parts and friction bearing surfaces exposed to the lunar dust may also be negatively affected. For example, it was found that boxes used to collect and return lunar samples to Earth were not tightly sealed due to the presence of lunar dust. In fact, all Apollo rock boxes leaked, most all the way from 10⁻¹² torr to one atmosphere of Earth air.

Returning humans to the Moon in the near-future will involve many considerations, designs, and engineering projects for exploration and ISRU activities. One factor common to all activities on the Moon is the ever-present, sharp, abrasive, glassy dust. Various ISRU activities will entail movement of the lunar regolith, but conventional means will launch a large portion of dust that will cause numerous problems as it falls back covering such installations as solar cells, for example.

Because of the presence of nanophase metallic Fe in the impact-produced glass, this “well-graded” soil can be sintered and melted into building blocks, antenna dishes, roads, etc. with the application of microwaves. Published U.S. Patent Application No. US2008/0003133, which is incorporated herein by reference, discloses a system for in-situ microwave consolidation of lunar soil. In addition to converting lunar dust into useful construction materials, the dust can be used for other applications. For example, the surfaces of the dust contain solar-wind particles, providing a potential source of hydrogen for water and fuel.

However, there is a down-side to the fine portion of the soil, the dust. It is prone to being “kicked up” by most activities on the surface of the Moon, thereby creating a plethora of problems, many experienced during the Apollo Missions, as discussed by Taylor et al., 2005, AIAA, 1st Space Explor. Conf., Orlando, Fla. Therefore, it is imperative to develop a method of handling and collecting lunar regolith that mitigates against the possibility of stirring too much dust into the lunar “atmosphere.”

### SUMMARY OF THE INVENTION

The present invention provides an apparatus and method for transporting lunar soil. A magnetic field is generated in a transport tube which attracts and moves the lunar soil through the tube. The magnetic field may be generated by multiple electrically conductive coils that are positioned coaxially and along the length of the transport tube.

The dust of the Moon is one of the major environmental challenges that we face in returning to the lunar surface. However, this dust can be of great use in making life on the Moon practical. In accordance with aspects of the present invention, the potential hazard of having this dust suspended above the surface is reduced or eliminated by using magnetic properties that are inherent in the lunar soil to transport the soil to a desired location. The transported lunar soil may then be used for various purposes.

An aspect of the present invention is to provide an apparatus for transport of lunar soil particles comprising: a transport tube having an interior passageway structured and arranged for the transport of the lunar soil particles therethrough; and a magnetic field generator structured arranged to generate a magnetic field capable of attracting and transporting the lunar soil particles through the interior passageway of the transport tube.

Another aspect of the present invention is to provide a method of transporting lunar soil particles, the method comprising: generating a magnetic field in the proximity of the lunar soil particles; and transporting the soil particles with the magnetic field.

These and other aspects of the present invention will be more apparent from the following description.

### BRIEF DESCRIPTION OF THE DRAWINGS

FIG. 1 is a partially schematic illustration of a lunar soil transport system in accordance with an embodiment of the present invention.

FIG. 2 is a partially schematic illustration of a lunar soil transport system in accordance with another embodiment of the present invention.

FIG. 3 is a back-scattered electron (BSE) image of Apollo 17 lunar soil;

FIG. 4 is an Fe X-ray map of the same soil illustrating the thin rim of metallic Fe on some of the soil grains; and

FIG. 5 is a TEM image of the same mature lunar soil sample, illustrating the presence of nano-phase metallic iron particles (np-Fe⁰) on the surfaces of the soil grains.

FIG. 6 is a BSE image of Apollo 17 lunar soil; FIG. 7 is an Fe X-ray map of the same soil showing the thin rim of metallic Fe on some grains; and FIG. 8 is a TEM image of the same immature lunar soil sample, illustrating the presence of nanophase metallic Fe (np-Fe⁰) on the surface of each soil particle.

### DETAILED DESCRIPTION

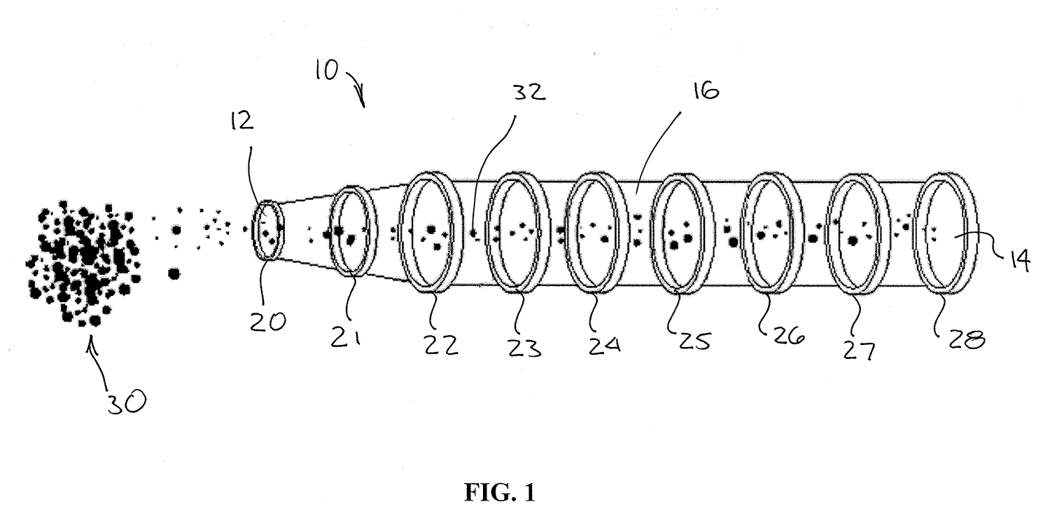

FIG. 1 schematically illustrates a lunar soil transport system 10 in accordance with an embodiment of the present invention. The system 10 includes a tube having an inlet end 12, an outlet end 14, and an interior passageway 16 therebetween. Several electrically conductive coils 20-28 are provided along the length of the passageway 16. Introduction of current through the coils 20-28 generates a magnetic field along the passageway 16 which attracts iron-containing lunar soil particles 30 and transports the individual particles 32 through the interior 16 of the system 10. By selectively controlling the current through the coils 20-28, the soil particles 32 are first introduced through the inlet end 12 by the magnetic field generated by the coil 20, and are transported along the length of the passageway 16 by alternatingly introducing current through the next coil in the sequence, while removing the current or reversing the direction of current in the preceding coil in order to draw the lunar soil particles along the length of the tube.

As shown in FIG. 1, the wound coils 20-28 may be individually powered to generate magnetic fields. Soil is picked up by the nose coil 20 and pulled into the center of the transport tube. As this moving soil approaches this first coil 20, the coil 20 is powered down, and the next coil 21 in the sequence is powered up and attracts the particles of soil further into the tube. As the soil approaches the second coil 21, it too is powered down, and the next coil 22 in the sequence is powered up to tractor the soil further down the line. This process of turning coils on and off continues in a “caterpillar/millipede effect” moving the soil particles along this electronic-conveyor belt. A lunar surface-mining operation may use this device to gather and transport soil and dust across great distances to processing plants.

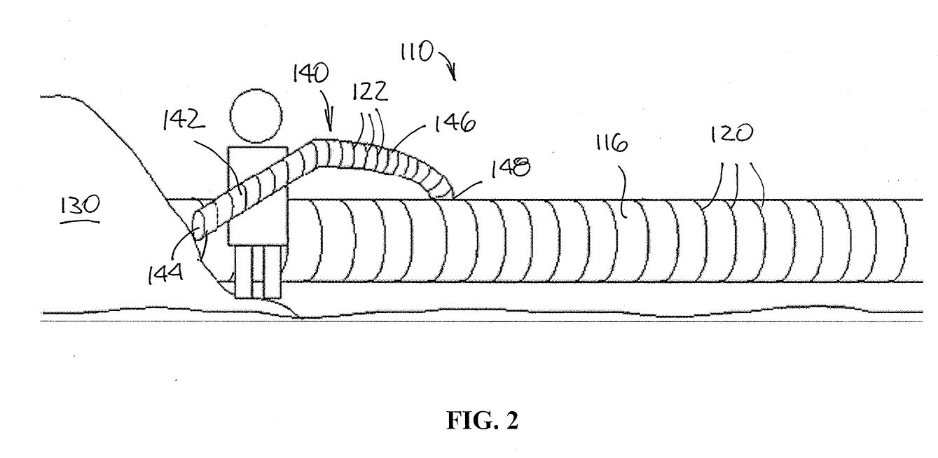

FIG. 2 schematically illustrates a lunar soil particle transport system 110 in accordance with another embodiment of the present invention. The main transport tube has an internal passageway 116 surrounded by multiple electrically conductive coils 120 for selectively generating magnetic fields in the passageway 116. A smaller feeder tube 140 having a relatively rigid section 142 and flexible section 146 is in flow communication with the interior passageway 116 of the main tube. The feeder tube 140 has an inlet end 144 and is connected to the main tube at its outlet end 148. Multiple electrically conductive coils 122 surround the feeder tube 140 for generating magnetic fields therein. In the embodiment shown in FIG. 2, the inlet end 144 of the feeder tube 140 is positioned adjacent to a mound 130 of planetary soil, and the feeder tube 140 is used to draw the lunar soil particles through the feeder tube 140 by the magnetic fields generated by the coils 122. The lunar soil particles exit the feeder tube 140 into the main tube 116 for transport to a desired location.

The system illustrated in FIG. 2 provides a trunk line that is capable of large magnetic fields and moving large amounts of material with several feeder lines. The feeder lines branch off of the trunk line, pulling in material from the surrounding area. This allows for several areas to be excavated simultaneously. As the regolith is exhausted in one large area, the trunk line can be extended to new areas. The magnetic fields must be sufficiently strong as to attract the soil from a reasonable distance and accelerate it to a speed sufficient to carry it to the next coil through momentum. In the case of the Moon, this is eased somewhat by both the absence of atmosphere and the ⅙th G gravity on the Moon (lighter to pick up vertically, and less drop in horizontal transport). It is also necessary to control the on-off timing needed to energize and relax consecutive rings, in order to keep a continuous flow of soil through the tube. The feedback-loop timing will maintain efficiency.

The present invention provides a system to mitigate the lunar dust problem utilizing its ferromagnetic properties, due to the presence of nanophase metallic Fe in the ˜40-50% impact glass of the lunar soil. The presence of 80-90% glass in the dust makes this portion of the soil capable of being attracted by a simple magnet. The presence of this Fe bearing glass in larger agglutinates also renders a magnetic susceptibility to the larger grain-sized soil particles. It should be possible to effectively “suck-up” the regolith using magnetic fields. This can be done in a similar fashion to the way maglev trains and coil guns (or gauss weapons) work, by using consecutive electro-magnets to pull an object along. A major advantage of these technologies is that there are no moving parts in the device. Such an attracting systems applied to the Moon would not only pull the soil along, but effectively capture the dust as well.

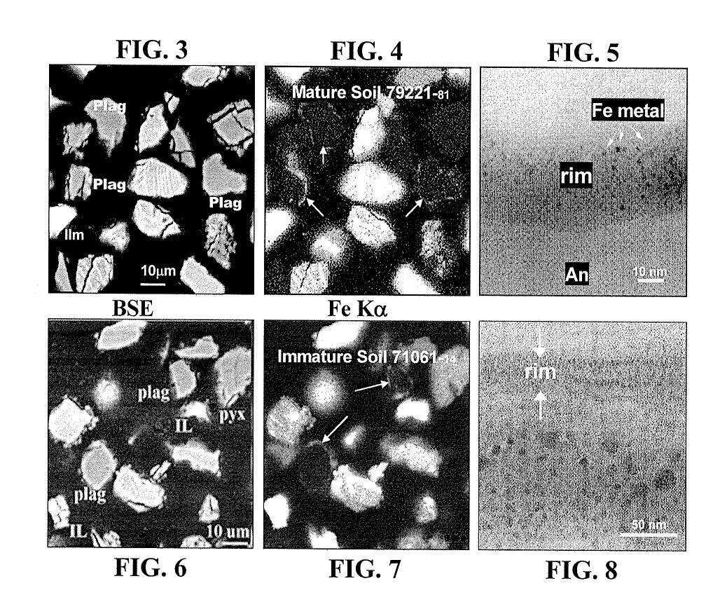

FIG. 3 is a back-scattered electron image, FIG. 4 is an Fe X-ray map, and FIG. 5 is a TEM image of a mature lunar soil sample, Apollo 17 Sample No. 79221, illustrating the presence of nanophase metallic iron particles (np-Fe⁰) on the surface of each soil particle.

FIG. 6 is a back-scattered electron image, FIG. 7 is an Fe X-ray map, and FIG. 8 is a TEM image of an immature lunar soil sample, Apollo 17 Sample No. 71061, illustrating the presence of nanophase metallic iron particles (np-Fe⁰) on the surface of each soil particle.

As shown in the back-scattered electron images of FIGS. 3 and 6, there are many plagioclase grains (CaAl₂Si₂O₈), as well as ilmenite (FeTiO₃) grains. In the Fe X-ray maps of FIGS. 4 and 7, a thin Fe rim is present on the plagioclase grains, giving them a significant bulk magnetic susceptibility. Both the mature (FIG. 4) and immature (FIG. 7) lunar soils have vapor-deposited coatings on rims of most grains. In the TEM images of FIGS. 5 and 8, the fine-grained nature of the nanophase Fe⁰ on the plagioclase grains is shown.

Lunar soil, especially lunar agglutinitic glass which is a major component in lunar dust, contains nano-sized metallic Fe (np-Fe⁰). The np-Fe⁰ typically has a size of less than 50 nm for example, from 3 to 30 nm. Such a np-Fe⁰ may pose severe problems for humans and equipment. However, the presence of np-Fe⁰ allows the lunar soil to be attracted by magnetic forces, and transported and stored in accordance with the present invention.

Whereas particular embodiments of this invention have been described above for purposes of illustration, it will be evident to those skilled in the art that numerous variations of the details of the present invention may be made without departing from the invention as defined in the appended claims.

1. An apparatus for transport of lunar soil particles comprising:
a transport tube having an interior passageway structured and arranged for the transport of the lunar soil particles therethrough; and
a magnetic field generator structured and arranged to generate a magnetic field capable of attracting and transporting the lunar soil particles through the interior passageway of the transport tube.

2. The apparatus of claim 1, wherein the magnetic field generator comprises a plurality of electrically conductive coils along a length of the transport tube.

3. The apparatus of claim 2, wherein the electrically conductive coils are coaxial with the transport tube.

4. The apparatus of claim 1, further comprising at least one feeder tube in flow communication with the interior passageway of the transport tube.

5. The apparatus of claim 4, wherein the at least one feeder tube comprises a magnetic field generator.

6. The apparatus of claim 5, wherein the magnetic field generator of the feeder tube comprises a plurality of electrically conductive coils along a length of the feeder tube.

7. The apparatus of claim 6, wherein the electrically conductive coils are coaxial with the feeder tube.

8. The apparatus of claim 1, wherein the lunar soil particles comprise nanophase metallic iron particles.

9. A method of transporting lunar soil particles, the method comprising:
generating a magnetic field in the proximity of the lunar soil particles; and
transporting the soil particles with the magnetic field.

10. The method of claim 9, wherein the lunar soil particles comprise nanophase metallic iron particles.

11. The method of claim 9, wherein the method is conducted on a surface of the Moon.
